(19) United States
(12) Patent Application Publication
(10) Pub. No.: US 2021/0352928 A1
(43) Pub. Date: Nov. 18, 2021

(54) OXIDIZED PRODUCT OF PALM-BASED OIL AND FAT, METHOD FOR PRODUCING OXIDIZED PRODUCT, METHOD FOR ENHANCING FOOD SWEETNESS, AND COMPOSITION FOR ENHANCING FOOD SWEETNESS

(71) Applicant: J-OIL MILLS, Inc., Tokyo (JP)

(72) Inventors: Shun MATSUZAWA, Tokyo (JP); Masayoshi SAKAINO, Tokyo (JP); Misaki TSUJI, Tokyo (JP); Takahiro TOKUCHI, Tokyo (JP); Takashi SANO, Tokyo (JP)

(21) Appl. No.: 17/287,192

(22) PCT Filed: Oct. 24, 2019
(86) PCT No.: PCT/JP2019/041660

§ 371 Date: Apr. 21, 2021

(30) Foreign Application Priority Data
Oct. 31, 2018 (JP) 2018-206140

(51) Int. Cl. A23D 9/04; A23L 27/20

(52) U.S. Cl. CPC A23D 9/04; A23L 27/2028

(57) ABSTRACT

Provided is an edible material having an exceptional sweetness-enhancing effect. This oxidized product of a palm-based oil and fat has a total content of α-carotene and β-carotene of 50 mass ppm or more and 2000 mass ppm or less, and a peroxide value of the oxidized product of 3 or more and 250 or less.

### TECHNICAL FIELD

The present invention relates to an oxidized product of palm-based oil and fat having an exceptional sweetness-enhancing effect, and usage thereof.

### BACKGROUND ART

Various edible materials having an exceptional effect for enhancing sweetness are known in the art. For example, patent document 1 discloses a method of enhancing the sweetness of a food using a long-chain highly unsaturated fatty acid and/or ester thereof. Also, for example, patent document 2 discloses a sweetness enhancer containing, as an active ingredient, an oxidized partially hydrogenated oil and fat having a peroxide value of 25 to 300. Also, for example, patent document 3 discloses a sweetness enhancer containing, as an active ingredient, an oxidized oil and fat having a peroxide value of 15 to 180 and containing 10 mass % or more and 100 mass % or less of milk fat.

### RELATED ART DOCUMENTS

### Patent Documents

Patent Document 1: Japanese Laid-Open Patent Application No. 2009-284859

Patent Document 2: International Publication No. 2014/077019

Patent Document 3: International Publication No. 2018/037926

### DISCLOSURE OF THE INVENTION

### Problems the Invention is Intended to Solve

However, in view of an increased diversity of consumer tastes and needs from food business operators, there has been a need to provide new materials having different origins from the conventional materials.

Consequently, the purpose of the present invention is to provide an edible material with an exceptional effect for enhancing sweetness.

### Means for Solving the Aforementioned Problems

A first aspect of the present invention provides an oxidized product of a palm-based oil and fat, wherein the palm-based oil and fat has a total content of α-carotene and β-carotene of 50 mass ppm or more and 2000 mass ppm or less, and a peroxide value of the oxidized product of 3 or more and 250 or less.

A second aspect of the present invention provides an oil and fat composition containing the oxidized product described above.

The oil and fat composition is preferably for heated cooking.

A third aspect of the present invention further provides a method for producing an oxidized product, comprising a step for oxidizing a palm-based oil and fat, which has a total content of α-carotene and β-carotene of 50 mass ppm or more and 2000 mass ppm or less, so that a peroxide value is 3 or more and 250 or less.

In the method for producing the oxidized product described above, it is preferred that the oxidizing step is carried out at a heating temperature of 50° C. or higher and 220° C. or lower, and a heating time of 0.1 hour or more and 240 hours or less.

In the method production method described above, it is preferred that the oxidizing step is carried out by supplying oxygen to the palm-based oil and fat.

On one hand, a fourth aspect of the present invention provides a method for enhancing food sweetness, wherein the oxidized product described above, or the oil and fat composition described above is included in a food.

In the method for enhancing food sweetness, it is preferred that 1×10⁻⁸ mass % or more and 10 mass % or less of the oxidized product is included in the food.

On the other hand, a fifth aspect of the present invention provides a composition for enhancing food sweetness, comprising an oxidized product of a palm-based oil and fat.

In the composition for enhancing food sweetness described above, it is preferred that the composition contains 1×10⁻⁸ mass % or more and 100 mass % or less of the oxidized product.

A sixth aspect of the present invention furthermore provides a food containing the oxidized product described above.

### Effect of the Invention

According to the present invention, it is possible to provide an edible material derived from a palm-based oil and fat and having an exceptional sweetness-enhancing effect.

### BRIEF DESCRIPTION OF THE DRAWINGS

FIG. 1 is a chart showing the results of a sensory evaluation of the sweetness of yogurt by the Time Intensity method in Test Example 7; and

FIG. 2 is a chart showing the results of a sensory evaluation of the sweetness of chocolate by the Time Intensity method in Test Example 8.

### BEST MODE FOR CARRYING OUT THE INVENTION

The present invention relates to an oxidized product of palm-based oil and fat as a food material having an exceptional sweetness-enhancing effect.

The palm-based oil and fat used in the present invention can be a palm-based oil and fat obtained from the fruit of an oil palm, and can be subjected to molecular distillation, fractionation, degumming, neutralization, decolorization, and deodorization, or other treatment. There is no particular limitation as to the treatment methods; methods ordinarily used in the processing and refining of oils and fats can be used. For example, fractionation can be carried out by way of such as solvent fractionation and low-temperature filtration. However, the total content of α-carotene and β-carotene is 50 mass ppm or more and 2000 mass ppm or less, preferably 50 mass ppm or more and 1500 mass ppm or less, more preferably 50 mass ppm or more and 1000 mass ppm or less, and even more preferably 50 mass ppm or more and 800 mass ppm or less. One type of the palm-based oil and fat may be used alone so that the total content of α-carotene and β-carotene is within the above range, or two or more types may be used in combination and mixed to be within the above-stated range.

In the present invention, the above-mentioned palm-based oils and fats are oxidized to obtain an oxidized product. The peroxide value (hereinafter, also referred to as “POV”) of the oxidized product is 3 or more and 250 or less, preferably 3 or more and 220 or less, more preferably 3 or more and 180 or less, and even more preferably 3 or more and 150. The POV can be measured according to “Standard Methods for the Analysis of Fat, Oil and Related Materials, 2.5.2 Peroxide Value” (Japan Oil Chemists' Society). Oxidizing a material so as to have a POV within the above-noted predetermined range makes it possible to obtain an edible material having an exceptional sweetness-enhancing effect.

There is no particular limitation as to the method for oxidizing a palm-based oil and fat as long as the POV can be brought into the above-noted predetermined range, but the method is preferably a heating treatment, and from the viewpoint of industrial scale production, the palm-based oil and fat is accommodated in a tank or other suitable container, after which the heating treatment is preferably carried out using an electrothermal type, direct flame burner type, microwave type, steam type, hot-air type, or other heating means provided to the container. The conditions of the heat treatment cannot be specified unconditionally, but heating is typically carried out at temperature of, e.g., 50° C. or higher and 220° C. or lower and a heating time of 0.1 hour or more and 240 hours or less. Heating is more typically carried out at temperature of, e.g., 60° C. or higher and 160° C. or lower and a heating time of 1 hour or more and 100 hours or less. As a condition of the integral amount of heating temperature (° C.)×heating time (hours), heating treatment is typically carried out with an integral amount of, e.g., 200 or more and 20,000 or less, and heating treatment is more typically carried out with an integral amount of, e.g., 220 or more and 18,000 or less. The heating treatment is even more typically carried out with an integral amount of, e.g., 240 or more and 15,000 or less. When the heating temperature is changed, the integral amount of heating temperature (° C.)×heating time (hours) can be calculated as an integral value of the heating temperature (° C.) prior to the temperature change×the heating time (hours) prior to the temperature change, and the heating temperature (° C.) after the temperature change×the heating time (hours) after the temperature change, otherwise can be alternatively calculated as an integral value of the heating temperature (° C.) over heating time (hours).

Further, in the heat treatment, oxygen (air) can be supplied by blowing oxygen, or by stirring to take in oxygen from an open space in the container. The oxygen source can be air or the like. Oxidation of the palm-based oil and fat is thereby promoted. In such a case, the amount of air to be supplied is preferably 0.001 to 2 L/min. per 1 kg of starting material oil and fat. For example, in the case of air, the amount is preferably 0.005 to 10 L/min., and is more preferably 0.01 to 5 L/min., per 1 kg of the starting material oil and fat.

Another suitable edible oil and fat can be added, as appropriate, to the oxidized product of a palm-based oil and fat obtained the manner described above, in a range that does not compromise the desired sweetness-enhancing functionality, to form an oil and fat composition containing the oxidized product. Examples of the other edible oil and fat includes: soybean oil, rapeseed oil (canola oil), palm oil, corn oil, olive oil, sesame oil, safflower oil, sunflower oil, cottonseed oil, rice bran oil, peanut oil, palm kernel oil, coconut oil, and other vegetable oils; beef tallow, pork fat, chicken fat fish oil, milk fat, and other animal fats; medium-chain fatty acid triglycerides; and processed oils and fats obtained by subjecting these oils and fats to separation, hydrogenation, transesterification. These edible oils and fats may be a single type used alone, or two or more types mixed together. There is no particular limitation as to the blending ratio, but from the viewpoint of leaving the desired sweetness-enhancing functionality uncompromised, the content of the oxidized product of a palm-based oil and fat with respect to the total mass of the content of the oxidized product of a palm-based oil and fat and the other edible oil and fat is preferably 1×10⁻⁸ mass % or more and less than 100 mass %, more preferably 1×10⁻⁷ mass % or more and less than 100 mass %, further preferably 1×10⁻⁶ mass % or more and less than 100 mass %, and even more preferably 1×10⁻⁵ mass % or more and less than 100 mass %. In the oil and fat composition, one type of oxidized product may be included in the other edible oil and fat, or two or more types of the oxidized product may be used in combination. When two or more types of the oxidized product are used in combination, the content is the total content of the two or more types.

A suitable additive material can furthermore be blended, as appropriate, into the oil and fat composition containing the oxidized product of a palm-based oil and fat obtained the manner described above, in a range that does not compromise the desired sweetness-enhancing functionality. Specific examples include: ascorbic acid fatty acid ester, lignan, coenzyme Q, γ-oryzanol, tocopherol, and other antioxidants; flavoring, spice extract, animal extract, fatty acid, and other flavor imparting material; and emulsifier, silicone, pigment, and the like.

There is no particular limitation as to the form of the oxidized product of the palm-based oil and fat obtained in the manner described above and the oil and fat composition containing the same; examples include margarine, shortening, fat spread, and powdered oil and fat. The oxidized product and the oil and fat composition can be used in various foods, and can be used particularly for the purpose of enhancing sweetness. In other words, a component derived from the oxidized product can be added to the food to enhance the sweetness of the food by using the composition as: a loosening oil, rice cooking oil, or other cooking oil; frying oil, roasting oil, or other heated cooking oil and fat; or kneading oil, injection oil, finishing oil, or other seasoning oil or the like in cooking, processing, or manufacturing of various foods, and alternatively in adding, mixing, applying, dissolving, dispersing, emulsifying, or otherwise incorporating the composition in a food after cooking, processing, or manufacturing various foods. There is no particular limitation as to the food obtained by application of the present invention. Examples include cakes, breads, and other bakery foods; whipped cream, hot cakes, madeleines, chocolates, cookies, and other western confectioneries; yogurt, almond tofu, pudding, jelly, and other cold confectioneries; ice cream, ice milk, lacto ice cream, and other ice confectioneries; corn soup, consommé soup, and other soups; beef stew, cream stew, and other stews; coffee drinks, milk drinks, and other beverages; grilled pork, roasted pork fillet, and other processed meat foods; beef cutlets, pork cutlets, chicken cutlets, deep fried chicken, Tatsuta fried chicken, donuts, and other fried foods; scrambled eggs, fried eggs, and other stir fry foods; and kamaboko, fish sausage, and other processed marine foods. Particularly preferred among these are western confectioneries, cold confectioneries, ice confectioneries, soups, beverages, fried foods, and the like.

There is no particular limitation as to the blending ratio in a food; the content of the oxidized product of a palm-based oil and fat with respect to the total mass of the oxidized product of a palm-based oil and fat and the food to be added with the same is preferably 1×10⁻⁸ mass % or more and less than 10 mass % or less, more preferably 1×10⁻⁷ mass % or more and 10 mass % or less, further preferably 1×10⁻⁶ mass % or more and 10 mass % or less, and even more preferably 1×10⁻⁵ mass % or more and 10 mass % or less.

An oxidized product of the palm-based oil and fat obtained in the manner described above can be the form of a composition for enhancing the sweetness of food containing the same. In this case, there is no particular limitation as to the formulated form as long as the form can contain the oxidized product, can be kept in a good dispersed state or stable, and can be added and used in foods. For example, a liquid oil and fat, margarine, shortening, fat spread, powdered oil and fat, or the like, which are mainly composed of oil and fat, may be prepared by a formulation technique well known to a person skilled in the art, and may alternatively be prepared in the form of a solution, powder, gel, granule, or the like in which the blended amount of the oil and fat component is low, and these forms can be arbitrarily used. The oxidized product of the palm-based oil and fat and an oil and fat composition containing the same can be used in an unchanged form of a composition for enhancing the sweetness of food.

The content of the oxidized product in the composition for enhancing the sweetness of a food can be determined from the viewpoint of a suitable amount desired when applied to the food, there being no particular limitation thereto. Typically, the content is, e.g., preferably 1×10⁻⁸ mass % or more and 100 mass % or less, more preferably 1×10⁻⁷ mass % or more and 100 mass % or less, further preferably 1×10⁻⁶ mass % or more and 100 mass % or less, and even more preferably 1×10⁻⁵ mass % or more and 100 mass % or less. There is no particular limitation as to the application thereof; for example, when the composition for enhancing food sweetness is in the form of oil and fat for chocolate, powdered oil and fat, margarine or an oil and fat for heated cooking, the content of the noted oxidized products is preferably prepared in the following ranges.

Oil and fat for chocolate: 1×10⁻⁶ mass % or more and 70 mass % or less
Powdered oil and fat: 3×10⁻⁶ mass % or more and 100 mass % or less
Margarine: 2×10⁻⁶ mass % or more and 95% mass % or less
Oil and fat for heated cooking: 1×10⁻⁶ mass % or more and 10 mass % or less

In the composition for enhancing the sweetness of food, one type of oxidized product may be included, or two or more types of the oxidized product may be used in combination. When two or more types of the oxidized product are used in combination, the content is the total content of the two or more types.

The mode in which the composition for enhancing the sweetness of a food is used is the same as that for the oxidized product of a palm-based oil and fat or an oil and fat composition containing the same, and can be used, as appropriate, so that the food contains a desired amount. In such a case, from the viewpoint of the sweetness-enhancing effect, the composition for enhancing the sweetness of a food is preferably included in the food so that the content of the oxidized product is 1×10⁻⁸ mass % or more and 10 mass % or less, more preferably 1×10⁻⁷ mass % or more and 10 mass % or less, further preferably 1×10⁻⁶ mass % or more and 10 mass % or less, and even more preferably 1×10⁻⁵ mass % or more and 10 mass % or less.

### EXAMPLES

Hereinbelow, the present invention will be described in greater detail using examples, but these examples do not limit the present invention in any way.

First, the palm-based oils and fats used in this example will be listed below, and a method for quantifying α-carotene and β-carotene will be described.

### [Palm-Based Oil and Fat]

Red palm oil (no refining, low-temperature filtration): Total content of α-carotene and β-carotene, 341 mass ppm, EV REDPALM OIL, manufactured by Rainforest Herbs

Red palm oil (molecular distillation, double fractionation): Total content of α-carotene and β-carotene, 411 mass ppm, Carotino Premium, manufactured by Carotino

Red palm oil (molecular distillation, single fractionation): Total content of α-carotene and β-carotene, 373, 470, 444, and 457 mass ppm, Carotino Pure Olein, manufactured by Carotino

Formulated red palm oil (molecular distillation, single fractionation): The above-noted red palm oil (molecular distillation, single fractionation) and palm olein (manufactured by J-Oil Mills Co., Ltd., in-house prepared product) were blended at a ratio of 1:2. Total content of α-carotene and β-carotene: 114 mass ppm

[Quantification of α-Carotene and β-Carotene]

Quantification of α-carotene and β-carotene was carried out by analysis by high-performance liquid chromatography (HPLC analysis). Specifically, 0.5 g of a palm-based oil and fat or an oxidized product were weighed, each was diluted in a measuring flask in 10 mL of acetone and tetrahydrofuran in a 1:1 ratio, and subjected to HPLC analysis to quantify the contents of α-carotene and β-carotene from a calibration curve. The calibration curve uses reagents (manufactured by Wako Pure Chemical Industries, Ltd.) of α-carotene (model number 035-17981) and β-carotene (model number 035-05531) as quantitative samples, and was created from a peak area when subjected to HPLC analysis for each predetermined concentration. The main analysis conditions are shown below.

(HPLC Conditions)

Detector: Photodiode array detector “2996 PHOTODIODE ARRAY DETECTOR” (Waters), detected at 300-600 nm.

Column: Shim-pack VP-ODS, 4.6 mm ID×250 mm, 4.6 μm (Shimadzu Corporation)

Column temperature: 50° C.

Injection amount: 5 μL

Flow rate: 1.2 mL/min.

Mobile phase A: acetonitrile

Mobile phase B: ethanol

Mobile phase C: acetone

Gradient conditions: See Table 1

TABLE 1
Gradient conditions

| Minutes | A (capacity %) | B (capacity %) | C (capacity %) |
|---|---|---|---|
| 0 | 80 | 20 | 0 |
| 22.0 | 80 | 20 | 0 |
| 22.1 | 0 | 0 | 100 |
| 25.0 | 0 | 0 | 100 |
| 25.1 | 80 | 20 | 0 |
| 30.0 | 80 | 20 | 0 |

[Measurement of the Peroxide Value (POV)]

The POV was measured according to “Standard Methods for the Analysis of Fat, Oil and Related Materials, 2.5.2 Peroxide Value” (Japan Oil Chemists' Society).

### Test Example 1

Various palm-based oils and fats shown in Table 2 were used, and oxidized products thereof were prepared. Specifically, palm-based oils and fats containing a predetermined content (mass ppm) of α-carotene and β-carotene were prepared and heat-treated under the heat treatment conditions shown in Table 2 while stirring to obtain the oxidized products of Examples 1 to 25. Except for Example 18, the heating treatment was performed while blowing air at a predetermined rate (0.01 L/min, 0.1 L/min., or 0.2 L/min.). Further, one of the starting material red palm oils which was not heat-treated was used as a control in Comparative Example 1.

Table 2 shows the red palm oil which was used, the total content of α-carotene and β-carotene in the red palm oil, the heat treatment conditions, the total residual amount of α-carotene and β-carotene after the heat treatment, and the peroxide values (POV) measured before and after the heat treatment.

TABLE 2

| | | Carotene | | | Carotene | | |
|---|---|---|---|---|---|---|---|
| | | content* | Heat treatment conditions | | residual | POV | |
| | Palm-based oil and | (mass | Temperature | Air-blowing | amount** | Before | After |
| | fat | ppm) | and time | rate | (mass ppm) | heating | heating |
| Comparative | Red palm oil (molecular | 373 | — | — | 373 | 1 | — |
| Example 1 | distillation, single | | | | | | |
| | fractionation) | | | | | | |
| Example 1 | Red palm oil (no | 341 | 120° C. (5 h) → 80° C. (5 h) | 0.2 L/min | 198 | 1 | 17 |
| | refining, low- | | | | | | |
| | temperature filtration) | | | | | | |
| Example 2 | Red palm oil (molecular | 373 | 120° C. (5 h) → 80° C. (5 h) | 0.2 L/min | 172 | 1 | 22 |
| | distillation, single | | | | | | |
| | fractionation) | | | | | | |
| Example 3 | Red palm oil (molecular | 470 | 140° C. (4 h) | 0.2 L/min | 0 | 1 | 75 |
| | distillation, single | | | | | | |
| | fractionation) | | | | | | |
| Example 4 | Red palm oil (molecular | 373 | 120° C. (8 h) | 0.2 L/min | 92 | 1 | 28 |
| | distillation, single | | | | | | |
| | fractionation) | | | | | | |
| Example 5 | Red calm oil (molecular | 373 | 120° C. (10 h) | 0.2 L/min | 36 | 1 | 17 |
| | distillation, single | | | | | | |
| | fractionation) | | | | | | |
| Example 6 | Red palm oil (molecular | 373 | 120° C. (13 h) | 0.2 L/min | 0 | 1 | 53 |
| | distillation, single | | | | | | |
| | fractionation) | | | | | | |
| Example 7 | Red calm oil (molecular | 373 | 120° C. (14 h) | 0.2 L/min | 0 | 1 | 66 |
| | distillation, single | | | | | | |
| | fractionation) | | | | | | |
| Example 8 | Red palm oil (molecular | 373 | 120° C. (15 h 15 min) | 0.2 L/min | 0 | 1 | 99 |
| | distillation, single | | | | | | |
| | fractionation) | | | | | | |
| Example 9 | Red palm oil (molecular | 444 | 103° C. (14 h) | 0.2 L/min | 345 | 1 | 18 |
| | distillation, single | | | | | | |
| | fractionation) | | | | | | |
| Example 10 | Red palm oil (molecular | 444 | 103° C. (26 h) | 0.2 L/min | 196 | 1 | 32 |
| | distillation, single | | | | | | |
| | fractionation) | | | | | | |
| Example 11 | Red palm oil (molecular | 444 | 103° C. (35 h) | 0.2 L/min | 89 | 1 | 46 |
| | distillation, single | | | | | | |
| | fractionation) | | | | | | |
| Example 12 | Red palm oil (molecular | 444 | 103° C. (42 h) | 0.2 L/min | 0 | 1 | 60 |
| | distillation, single | | | | | | |
| | fractionation) | | | | | | |
| Example 13 | Red palm oil (molecular | 444 | 80° C. (31 h) | 0.2 L/min | 411 | 1 | 12 |
| | distillation, single | | | | | | |
| | fractionation) | | | | | | |
| Example 14 | Red palm oil (molecular | 444 | 80° C. (93 h) | 0.2 L/min | 221 | 1 | 37 |
| | distillation, single | | | | | | |
| | fractionation) | | | | | | |
| Example 15 | Red palm oil (molecular | 444 | 80° C. (134 h) | 0.2 L/min | 92 | 1 | 54 |
| | distillation, single | | | | | | |
| | fractionation) | | | | | | |
| Example 16 | Red palm oil (molecular | 444 | 80° C. (165 h) | 0.2 L/min | 0 | 1 | 62 |
| | distillation, single | | | | | | |
| | fractionation) | | | | | | |
| Example 17 | Red palm oil (molecular | 444 | 80° C. (182 h) | 0.2 L/min | 0 | 1 | 80 |
| | distillation, single | | | | | | |
| | fractionation) | | | | | | |
| Example 18 | Red palm oil (molecular | 470 | 103° C. (46 h) | None | 0 | 1 | 81 |
| | distillation, single | | | | | | |
| | fractionation) | | | | | | |
| Example 19 | Red palm oil (molecular | 457 | 103° C. (35 h) | 0.01 L/min | 128 | 1 | 37 |
| | distillation, single | | | | | | |
| | fractionation) | | | | | | |
| Example 20 | Red palm oil (molecular | 457 | 103° C. (53 h) | 0.01 L/min | 0 | 1 | 115 |
| | distillation, single | | | | | | |
| | fractionation) | | | | | | |
| Example 21 | Red palm oil (molecular | 470 | 103° C. (32 h) | 0.1 L/min | 103 | 1 | 41 |
| | distillation, single | | | | | | |
| | fractionation) | | | | | | |
| Example 22 | Red palm oil (molecular | 470 | 103° C. (44 h) | 0.1 L/min | 0 | 1 | 96 |
| | distillation, single | | | | | | |
| | fractionation) | | | | | | |
| Example 23 | Formulated red palm oil | 114 | 103° C. (64 h) | 0.2 L/min | 0 | 0 | 216 |
| | (molecular | | | | | | |
| | distillation, single | | | | | | |
| | fractionation) | | | | | | |
| Example 24 | Red palm oil (molecular | 411 | 120° C. (5 h) → 80° C. (5 h) | 0.2 L/min | 196 | 1 | 28 |
| | distillation, double | | | | | | |
| | fractionation) | | | | | | |
| Example 25 | Red palm oil (molecular | 373 | 120° C. (2 h) | 0.2 L/min | 265 | 1 | 8 |
| | distillation, single | | | | | | |
| | fractionation) | | | | | | |

*Carotene content: Total content of α-carotene and β-carotene.
**Residual amount of carotene: Total residual amount of α-carotene and β-carotene.

As shown in Table 2, the content of α-carotene and β-carotene contained in palm-based oils and fats is reduced by heat treatment, and all of the α-carotene and β-carotene in palm-based oils and fats was decomposed by heating for a longer period of time or increasing the temperature. On the other hand, the peroxide values (POV) increased due to the heat treatment. The total residual amount of α-carotene and β-carotene in Example 19 (heating temperature: 103° C., heating time: 35 hr, and air-blowing rate: 0.01 L/min) was 128 mass ppm, whereas the total residual amount of α-carotene and β-carotene in Example 21 (heating temperature: 103° C., heating time: 32 hr, air-blowing rate: 0.1 L/min) was 103 mass ppm, and the decomposition of α-carotene and β-carotene was promoted by blowing air. However, all of the α-carotene and β-carotene in red palm-based oils and fats was decomposed by heating, even without blowing air.

(Sensory Evaluation)

A sensory evaluation was conducted for the oxidized products of Comparative Example 1 and Examples 1 to 25. Specifically, the oxidized product was added to corn soup (corn soup was obtained by adding 150 mL of hot water to Knorr cup soup corn cream, manufactured by Ajinomoto Co., Inc., 17.6 g of powdered corn soup) and consumed. The intensity of sweetness in each of the first taste, the middle taste, and the aftertaste was evaluated by relative comparison with the case in which the oxidized product was not added. The sensory evaluation was conducted by an expert panel of 4 or 5 people, and the median value was calculated by scoring according to the following criteria. In addition, the obtained median value results were ranked on the following five-point scale.

(Criteria)

3 Very intense

2 Intense

1 Somewhat intense

0 Same

−1 Somewhat weak

−2 Weak

−3 Very weak

(Five-Point Scale)

A 2≤Median value

B 1<Median value<2

C 0.75≤Median value≤1

D 0<Median value<0.75

E −3≤Median value≤0

The results are shown in Table 3.

TABLE 3

| | | | Corn soup | | Median value of sensory | | | Sensory | | |
|---|---|---|---|---|---|---|---|---|---|---|
| | Oxidized product | | Content of | | evaluation | | | evaluation results | | |
| | | Carototene | oxidized | Carotene | (n = 4 or 5) | | | (5-point scale) | | |
| | Palm-based-oil | content* | product | content** | First | Middle | | First | Middle | |
| | and fat | (mass ppm) | (mass ppm) | (mass ppm) | taste | taste | Aftertaste | taste | taste | Aftertaste |
| Comparative | Red palm oil | 373 | 40 | 0.01 | 0 | 0.5 | 0.25 | E | D | D |
| Example 1 | (molecular | | | | | | | | | |
| | distillation, single | | | | | | | | | |
| | fractionation) | | | | | | | | | |
| Example 1 | Red palm oil (no | 341 | 40 | 0.01 | 0.75 | 1.25 | 1.5 | C | B | B |
| | refining, low- | | | | | | | | | |
| | temperature | | | | | | | | | |
| | filtration) | | | | | | | | | |
| Example 2 | Red palm oil | 373 | 40 | 0.01 | 1 | 1.5 | 1.5 | C | B | B |
| | (molecular | | | | | | | | | |
| | distillation, single | | | | | | | | | |
| | fractionation) | | | | | | | | | |
| Example 3 | Red palm oil | 470 | 40 | 0.02 | 1.25 | 1.75 | 1.75 | B | B | B |
| | (molecular | | | | | | | | | |
| | distillation, single | | | | | | | | | |
| | fractionation) | | | | | | | | | |
| Example 4 | Red palm oil | 373 | 40 | 0.01 | 1.25 | 1.75 | 1.5 | B | B | B |
| | (molecular | | | | | | | | | |
| | distillation, single | | | | | | | | | |
| | fractionation) | | | | | | | | | |
| Example 5 | Red palm oil | 373 | 40 | 0.01 | 1.25 | 1.75 | 1.5 | B | B | B |
| | (molecular | | | | | | | | | |
| | distillation, single | | | | | | | | | |
| | fractionation) | | | | | | | | | |
| Example 6 | Red palm oil | 373 | 40 | 0.01 | 1 | 1.5 | 1.75 | C | B | B |
| | (molecular | | | | | | | | | |
| | distillation, single | | | | | | | | | |
| | fractionation) | | | | | | | | | |
| Example 7 | Red palm oil | 373 | 40 | 0.01 | 1.25 | 2.25 | 1.5 | B | A | B |
| | (molecular | | | | | | | | | |
| | distillation, single | | | | | | | | | |
| | fractionation) | | | | | | | | | |
| Example 8 | Red palm oil | 373 | 40 | 0.01 | 1.25 | 1.75 | 2 | B | B | A |
| | (molecular | | | | | | | | | |
| | distillation, single | | | | | | | | | |
| | fractionation) | | | | | | | | | |
| Example 9 | Red palm oil | 444 | 40 | 0.02 | 1 | 1.25 | 1.75 | C | B | B |
| | (molecular | | | | | | | | | |
| | distillation, single | | | | | | | | | |
| | fractionation) | | | | | | | | | |
| Example 10 | Red palm oil | 444 | 40 | 0.02 | 1 | 1.5 | 1.25 | C | B | B |
| | (molecular | | | | | | | | | |
| | distillation, single | | | | | | | | | |
| | fractionation) | | | | | | | | | |
| Example 11 | Red palm oil | 444 | 40 | 0.02 | 1 | 1.5 | 1.5 | C | B | B |
| | (molecular | | | | | | | | | |
| | distillation, single | | | | | | | | | |
| | fractionation) | | | | | | | | | |
| Example 12 | Red palm oil | 444 | 40 | 0.02 | 1.25 | 1.75 | 1.5 | B | B | B |
| | (molecular | | | | | | | | | |
| | distillation, single | | | | | | | | | |
| | fractionation) | | | | | | | | | |
| Example 13 | Red palm oil | 444 | 40 | 0.02 | 0.75 | 1.25 | 1.5 | C | B | B |
| | (molecular | | | | | | | | | |
| | distillation, single | | | | | | | | | |
| | fractionation) | | | | | | | | | |
| Example 14 | Red palm oil | 444 | 40 | 0.02 | 1 | 1.25 | 1 | C | B | C |
| | (molecular | | | | | | | | | |
| | distillation, single | | | | | | | | | |
| | fractionation) | | | | | | | | | |
| Example 15 | Red palm oil | 444 | 40 | 0.02 | 1 | 1.25 | 1.25 | C | B | B |
| | (molecular | | | | | | | | | |
| | distillation, single | | | | | | | | | |
| | fractionation) | | | | | | | | | |
| Example 16 | Red palm oil | 444 | 40 | 0.02 | 1 | 1.25 | 1.5 | C | B | B |
| | (molecular | | | | | | | | | |
| | distillation, single | | | | | | | | | |
| | fractionation) | | | | | | | | | |
| Example 17 | Red palm oil | 444 | 40 | 0.02 | 1.5 | 1.75 | 1.75 | B | B | B |
| | (molecular | | | | | | | | | |
| | distillation, single | | | | | | | | | |
| | fractionation) | | | | | | | | | |
| Example 18 | Red palm oil | 470 | 40 | 0.02 | 0.75 | 0.75 | 1.25 | C | C | B |
| | (molecular | | | | | | | | | |
| | distillation, single | | | | | | | | | |
| | fractionation) | | | | | | | | | |
| Example 19 | Red palm oil | 457 | 40 | 0.02 | 1 | 1.25 | 1.5 | C | B | B |
| | (molecular | | | | | | | | | |
| | distillation, single | | | | | | | | | |
| | fractionation) | | | | | | | | | |
| Example 20 | Red palm oil | 457 | 40 | 0.02 | 1.25 | 2 | 1.75 | B | A | B |
| | (molecular | | | | | | | | | |
| | distillation, single | | | | | | | | | |
| | fractionation) | | | | | | | | | |
| Example 21 | Red palm oil | 470 | 40 | 0.02 | 0.75 | 1.5 | 1 | C | B | C |
| | (molecular | | | | | | | | | |
| | distillation, single | | | | | | | | | |
| | fractionation) | | | | | | | | | |
| Example 22 | Red palm oil | 470 | 40 | 0.02 | 1 | 1.75 | 1.75 | C | B | B |
| | (molecular | | | | | | | | | |
| | distillation, single | | | | | | | | | |
| | fractionation) | | | | | | | | | |
| Example 23 | Formulated red palm | 114 | 200 | 0.02 | 1 | 1.75 | 1.5 | C | B | B |
| | oil (molecular | | | | | | | | | |
| | distillation, single | | | | | | | | | |
| | fractionation) | | | | | | | | | |
| Example 24 | Red palm oil | 411 | 40 | 0.02 | 1 | 1 | 1.25 | C | C | B |
| | (molecular | | | | | | | | | |
| | distillation, double | | | | | | | | | |
| | fractionation) | | | | | | | | | |
| Example 25 | Red palm oil | 373 | 40 | 0.01 | 0.75 | 1.25 | 1.25 | C | B | B |
| | (molecular | | | | | | | | | |
| | distillation, single | | | | | | | | | |
| | fractionation) | | | | | | | | | |

*Carotene content: Total content of α-carotene and β-carotene.
**Content of carotene in corn soup: Amount converted to total content of α-carotene and β-carotene prior to heat treatment

As a result, as seen by the results in Comparative Example 1, the starting material red palm oil which had not undergone heat treatment was added to the corn soup, and the corn soup was consumed. The first taste was judged to be E on the 5-point scale of sweetness, the middle taste and aftertaste were judged to be D, and the effect of enhancing the sweetness of corn soup was poor. On the other hand, as seen by the results in Examples 1 to 25, with the oxidized product obtained by a certain degree of heat treatment, the first taste, the middle taste, and the aftertaste when the corn soup is consumed were judged to be A, B, or C on the 5-point scale of sweetness, and depending on the type of palm-based oil and fat used and the degree of heat treatment, a better judgment of B or even better judgment of A were also obtained, and an exceptional sweetness-enhancing effect was demonstrated.

Moreover, a sweetness-enhancing effect on the corn soup was observed when the peroxide value (POV) after the heat treatment was in the range of 8 or more and 216 or less.

### Test Example 2

(Evaluation with Yogurt)

<Preparation of the Oxidized Product of Example 26>

The method for preparing an oxidized product (Example 26) used in the present test example will be described. An oxidized product was obtained by heat-treating while stirring red palm oil having a total content of α-carotene and β-carotene of 300 mass ppm at 140° C. for 11 hours without blowing air. At this point, the residual amount of carotene in the oxidized product was 0 mass ppm and the peroxide value (POV) was 41.9.

<Preparation of an Oil and Fat Composition>

One percent by mass of the oxidized product prepared above was included in rapeseed oil, and an oil and fat composition containing 3 mass ppm was prepared using an amount obtained by converting the total content of α-carotene and β-carotene into the total content of the α-carotene and β-carotene before the heat treatment.

<Preparation and Evaluation of Yogurt)

The oil and fat composition prepared above (indicated in Table 4 as “rapeseed oil (containing 1 mass % of the ‘oxidized product of Example 26’)”) with the blends shown in Table 4 was included in yogurt (Meiji Bulgaria yogurt LB81 low sugar, manufactured by Meiji Co., Ltd.) to prepare yogurt, and the resulting yogurt was subjected to a sensory evaluation. Specifically, the intensity of sweetness when the yogurt is consumed was evaluated by relative comparison with the case in which the oil and fat composition prepared above (indicated in Table 4 as “rapeseed oil (containing 1 mass % of the ‘oxidized product of Example 26’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

Table 4

TABLE 4

| | | Preparation | Preparation | Preparation | Preparation |
|---|---|---|---|---|---|
| | | Example 2-1 | Example 2-2 | Example 2-3 | Example 2-4 |
| Yogurt | | 99 | 99 | 99 | 99 |
| Rapeseed oil | | 1 | 0.99 | 0.9 | 0 |
| Rapeseed oil | | 0 | 0.01 | 0.1 | 1 |
| (containing 1 mass % | | | | | |
| of the “oxidized | | | | | |
| product of | | | | | |
| Example 26”) | | | | | |
| Total (parts by mass) | | 100 | 100 | 100 | 100 |
| Carotene content* | | 0 | 3.0 × 10⁻⁴ | 3.0 × 10⁻³ | 3.0 × 10⁻² |
| (mass ppm) | | | | | |
| Result of | Panel 1 | 0 | 0.6 | 2.7 | 3 |
| sensory | Panel 2 | 0 | 1.2 | 2.4 | 3 |
| evaluation | Panel 3 | 0 | 1.8 | 2.4 | 2.7 |

| | | | | |
|---|---|---|---|---|
| Average value | 0 | 1.2 | 2.5 | 2.9 |

*Carotene content in the yogurt: Amount converted to the total content of α-carotene and β-carotene prior to heating treatment

As a result, it is apparent that the sweetness of the yogurt can be enhanced in a dosage-dependent fashion by the rapeseed oil-based oil and fat composition containing 1 mass % of the above-described oxidized product.

### Test Example 3

(Evaluation with Lacto Ice Cream)

<Preparation and Evaluation of Lacto Ice Cream>

The oil and fat composition prepared in Text Example 2 (indicated in Table 5 as “rapeseed oil (containing 1 mass % of the ‘oxidized product of Example 26’)”) with the blends shown in Table 5 was included in lacto ice cream (Meiji Essel Super Cup, manufactured by Meiji Co., Ltd.) to prepare lacto ice cream, and the resulting lacto ice cream was subjected to a sensory evaluation. Specifically, the intensity of sweetness when the lacto ice cream is consumed was evaluated by relative comparison with the case in which the oil and fat composition prepared in Test Example 2 (indicated in Table 5 as “rapeseed oil (containing 1 mass % of the ‘oxidized product of Example 26’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

[Table 5]

TABLE 5

| | | Preparation | Preparation | Preparation | Preparation |
|---|---|---|---|---|---|
| | | Example 3-1 | Example 3-2 | Example 3-3 | Example 3-4 |
| Lacto ice cream | | 99 | 99 | 99 | 99 |
| Rapeseed oil | | 1 | 0.99 | 0.9 | 0 |
| Rapeseed oil | | 0 | 0.01 | 0.1 | 1 |
| (containing 1 mass % | | | | | |
| of the “oxidized | | | | | |
| product of | | | | | |
| Example 26”) | | | | | |
| Total (parts by mass) | | 100 | 100 | 100 | 100 |
| Carotene content* | | 0 | 3.0 × 10⁻⁴ | 3.0 × 10⁻³ | 3.0 × 10⁻² |
| (mass ppm) | | | | | |
| Result of | Panel 1 | 0 | 1.2 | 2.4 | 3 |
| sensory | Panel 2 | 0 | 1.8 | 2.4 | 2 |
| evaluation | Panel 3 | 0 | 1.8 | 3 | 2 |

| | | | | |
|---|---|---|---|---|
| Average value | 0 | 1.6 | 2.6 | 3 |

*Carotene content in the lacto ice cream: Amount converted to the total of α-carotene and β-carotene prior to heating treatment

As a result, it is apparent that the sweetness of the lacto ice cream can be enhanced in a dosage-dependent fashion by the rapeseed oil-based oil and fat composition containing 1 mass % of the oxidized product prepared in Test Example 2.

### Test Example 4

(Evaluation with Whipped Cream)

<Preparation and Evaluation of Whipped Cream>

The oil and fat composition prepared in Test Example 2 (indicated in Table 6 as “rapeseed oil (containing 1 mass % of the ‘oxidized product of Example 26’)”) with the blends shown in Table 6 was included in and beat together with the vegetable cream (whipped vegetable fat, manufactured by Megmilk Snow Brand Co., Ltd.) to prepare whipped cream, and the resulting whipped cream was subjected to a sensory evaluation. Specifically, the intensity of sweetness when the whipped cream is consumed was evaluated by relative comparison with the case in which the oil and fat composition prepared in Test Example 2 (indicated in Table 6 as “rapeseed oil (containing 1 mass % of the ‘oxidized of Example 26’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 6

| | | Preparation | Preparation | Preparation | Preparation |
|---|---|---|---|---|---|
| | | Example 4-1 | Example 4-2 | Example 4-3 | Example 4-4 |
| Vegetable cream | | 183 | 183 | 183 | 183 |
| Granulated sugar | | 15 | 15 | 15 | 15 |
| Rapeseed oil | | 2 | 1.98 | 1.8 | 0 |
| Rapeseed oil | | 0 | 0.02 | 0.2 | 2 |
| (containing 1 mass % | | | | | |
| of the “oxidized | | | | | |
| product of | | | | | |
| Example 26”) | | | | | |
| Total (parts by mass) | | 200 | 200 | 200 | 200 |
| Carotene content* | | 0 | 3.0 × 10⁻⁴ | 3.0 × 10⁻³ | 3.0 × 10⁻² |
| (mass ppm) | | | | | |
| Result of | Panel 1 | 0 | 1.8 | 1.8 | 2.4 |
| sensory | Panel 2 | 0 | 1.8 | 2.1 | 2.4 |
| evaluation | Panel 3 | 0 | 1.8 | 2.4 | 3 |

| | | | | |
|---|---|---|---|---|
| Average value | 0 | 1.8 | 2.1 | 2.6 |

*Carotene content in the whipped cream: Amount converted to the total content of α-carotene and β-carotene prior to heating treatment

As a result, it is apparent that the sweetness of the whipped cream can be enhanced in a dosage-dependent fashion by the rapeseed oil-based oil and fat composition containing 1 mass % of the oxidized product prepared in Test Example 2.

### Test Example 5

(Evaluation with Coffee Drink)

<Preparation of Powdered Oil and Fat>

One percent by mass of the oxidized product of Example 26 was included in powdered oil and fat, and a powdered oil and fat containing 3 mass ppm was prepared using an amount obtained by expressing the total content of α-carotene and β-carotene as the total content of the α-carotene and β-carotene before the heat treatment. The powdered oil and fat was prepared using the method of paragraph [0046] of JP 2017-63784 A to contain 1 mass % of the oxidized product. Moreover, a powdered oil and fat (plain) containing no oxidized product was prepared by the same method.

(Preparation and Evaluation of a Coffee Drink)

A coffee drink was prepared with a blending ratio of 0.6 mass % of powdered coffee (Blendy, manufactured by Ajinomoto AGF Co., Ltd.), 2.6 mass % of granulated sugar, 2.9 mass % of powdered oil and fat (plain), and 93.9 mass % of hot water. Furthermore, the powdered oil and fat prepared above (indicated in Table 7 as “powdered oil and fat (containing 1 mass % of the ‘oxidized product of Example 26’)”) or a powdered oil and fat (plain) with the blend shown in Table 7 was furthermore included in the coffee drink to prepare the coffee drink, and the resulting coffee drink was subjected to a sensory evaluation. Specifically, the intensity of sweetness when the coffee drink is consumed was evaluated by relative comparison with the case in which the powdered oil and fat prepared above (indicated in Table 7 as “powdered oil and fat (containing 1 mass % of the ‘oxidized product of Example 26’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

—1 Somewhat weak

—2 Weak

—3 Very weak

TABLE 7

| | | Preparation | Preparation | Preparation | Preparation |
|---|---|---|---|---|---|
| | | Example 5-1 | Example 5-2 | Example 5-3 | Example 5-4 |
| Coffee drink | | 99 | 99 | 99 | 99 |
| Powdered oil and fat | | 1 | 0.99 | 0.9 | 0 |
| (plain) | | | | | |
| Powdered oil and fat | | 0 | 0.01 | 0.1 | 1 |
| (containing 1 mass % | | | | | |
| of the “oxidized | | | | | |
| product of | | | | | |
| Example 26”) | | | | | |
| Total (parts by mass) | | 100 | 100 | 100 | 100 |
| Carotene content* | | 0 | 3.0 × 10⁻⁴ | 3.0 × 10⁻³ | 3.0 × 10⁻² |
| (mass ppm) | | | | | |
| Result of | Panel 1 | 0 | 1.2 | 1.8 | 2.4 |
| sensory | Panel 2 | 0 | 1.2 | 1.8 | 2.4 |
| evaluation | Panel 3 | 0 | 1.2 | 1.8 | 2.4 |

| | | | | |
|---|---|---|---|---|
| Average value | 0 | 1.2 | 1.8 | 2.4 |

*Carotene content in the coffee drink: Amount converted to the total content of α-carotene and β-carotene prior to heating treatment

As a result, it is apparent that the sweetness of the coffee drink can be enhanced in a dosage-dependent fashion by the powdered oil and fat containing 1 mass % of the oxidized product of Example 26.

### Test Example 6

(Evaluation with Madeleine)

<Preparation of a Madeleine Dough>

A madeleine dough was prepared according to the blend shown in Table 8.

TABLE 8
(Madeleine dough)

| Starting material | Blend (parts by mass) |
|---|---|
| Egg | 100 |
| Sugar | 100 |
| Flour | 100 |
| Baking powder | 1.5 |
| Butter | 100 |
| Total | 401.5 |

Specifically, eggs were whipped in a bowl, sugar was added, the sugar was melted in a hot water bath and removed from the hot water bath, and flour and baking powder were added. The combination was mixed until smooth, melted butter was added in small amounts (3-4 times), and the combination was mixed to make dough. The dough was allowed to rest for 30 minutes to 1 hour.

<Preparation and Evaluation of the Madeleine Dough>

The powdered oil and fat prepared in Test Example 5 (indicated in Table 9 as “powdered oil and fat (containing 1 mass % of the ‘oxidized product of Example 26’)”) or the powdered oil and fat (plain) was used with the blends shown in Table 9 to prepare the madeleines. Specifically, the dough prepared above was divided into 45 g pieces and mixed with the powdered oil and fat or powdered oil and fat (plain), the dough was placed in a mold so as to form 6 or 7 portions, the mold was lightly tapped so as to flatten the dough, and the mold was placed in a warmed oven and baked at 170° C. for 15 minutes to obtain madeleine.

The resulting madeleine was subjected to a sensory evaluation. Specifically, the intensity of sweetness when the madeleine is consumed was evaluated by relative comparison with the case in which the powdered oil and fat prepared Test Example 5 (indicated in Table 9 as “powdered oil and fat (containing 1 mass % of the ‘oxidized product of Example 26’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 9

| | | Preparation | Preparation | Preparation | Preparation |
|---|---|---|---|---|---|
| | | Example 6-1 | Example 6-2 | Example 6-3 | Example 6-4 |
| Madeleine dough. | | 45 | 45 | 45 | 45 |
| Powdered oil and fat | | 5 | 4.95 | 4.5 | 0 |
| (plain) | | | | | |
| Powdered oil and fat | | 0 | 0.05 | 0.5 | 5 |
| (containing 1 mass % | | | | | |
| of the “oxidized | | | | | |
| product of | | | | | |
| Example 26”) | | | | | |
| Total (parts by mass) | | 50 | 50 | 50 | 50 |
| Carotene content* | | 0 | 3.0 × 10⁻⁴ | 3.0 × 10⁻³ | 3.0 × 10⁻² |
| (mass ppm) | | | | | |
| Result of | Panel 1 | 0 | 2 | 2.5 | 3 |
| sensory | Panel 2 | 0 | 1 | 2 | 3 |
| evaluation | Panel 3 | 0 | 1.5 | 2.5 | 2.5 |

| | | | | |
|---|---|---|---|---|
| Average value | 0 | 1.5 | 2.3 | 2.8 |

*Carotene content in the madeleine dough: Amount converted to the total content of α-carotene and β-carotene prior to heating treatment

As a result, it is apparent that the sweetness of the madeleine can be enhanced in a dosage-dependent fashion by the powdered oil and fat containing 1 mass % of the oxidized product of Example 26.

### Test Example 7

(Sensory Evaluation of Sweetness of Yogurt by the Time Intensity Method)

<Preparation of the Oxidized Product of Example 27>

An oxidized product was obtained by heat-treating while stirring red palm oil (molecular distillation, single fractionation) having a total content of α-carotene and β-carotene of 373 mass ppm at 103° C. for 40 hours and blowing air at a rate of 0.2 L/min. At this point, the residual amount of carotene in the oxidized product was 2 mass ppm and the peroxide value (POV) was 56.

<Preparation and Evaluation of Yogurt)

The oxidized product prepared above (Example 27) or the rapeseed oil as a comparison was included in yogurt with the blend shown in Table 10 (Meiji Bulgaria yogurt LB81 low sugar, manufactured by Meiji Co., Ltd.) to prepare yogurt, and the resulting yogurt was subjected to a sensory evaluation of yogurt sweetness by the Time Intensity method.

In the Time Intensity method, an evaluator operates an evaluation scale bar connected to a computer, whereby the sweetness perceived during the measurement is continuously evaluated, and the change in the intensity of the sweetness over time is measured. In the present test example, yogurt was placed in the mouth five seconds after the start of measurement, and the yogurt was chewed at a pace of 2 times per second from the start of measurement to 15 seconds and then swallowed. The measurement was further continued until 25 seconds after the start of measurement and then completed.

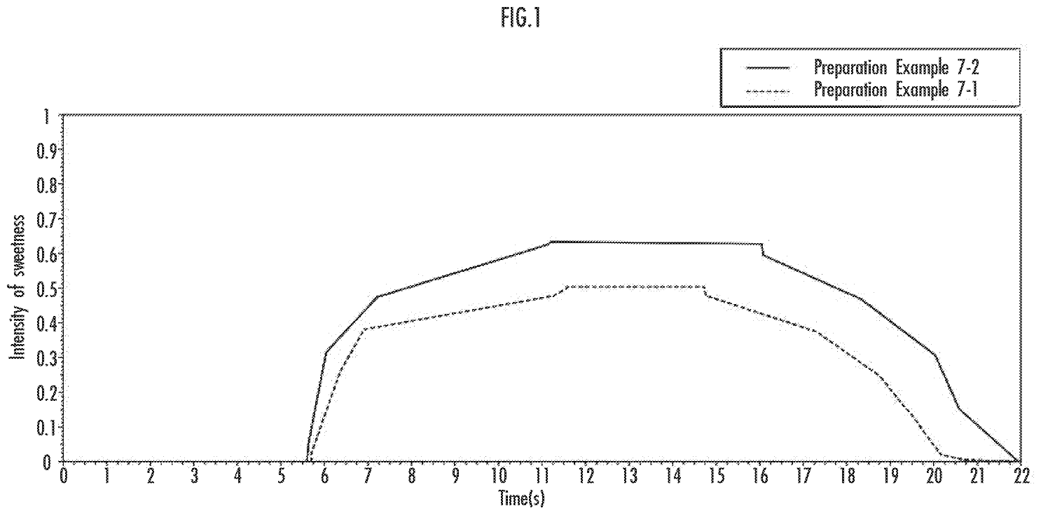

FIG. 1 shows the results of a sensory evaluation by the Time Intensity method.

TABLE 10

| | | Preparation | Preparation |
|---|---|---|---|
| | | Example 7-1 | Example 7-2 |
| Yogurt | | 48.25 | 48.25 |
| Granulated sugar | | 1.5 | 1.5 |
| Rapeseed oil | | 0.25 | 0.225 |
| Oxidized product of Example 27 | | 0 | 0.025 |
| Total (parts by mass) | | 50 | 50 |
| Carotene content* (mass ppm) | | 0 | 1.87 × 10⁻¹ |
| Results | Max. | 0.51 | 0.64 |
| of sensory | sweetness | | |
| evaluation | intensity | | |
| by the Time | Duration | 3.1 | 4.8 |
| Intensity | (sec.) of max. | | |
| method | sweetness | | |
| | intensity | | |

*Carotene content in the yogurt: Amount converted to the total content of α-carotene and β-carotene prior to heating treatment

As a result, in Preparation Example 7-1 in which rapeseed oil was blended with yogurt, the maximum sweetness intensity was 0.51 and the duration was 3.1 seconds, whereas in Preparation Example 7-2 in which in the oxidized product of Example 27 had been blended, the maximum sweetness intensity was 0.64 and the duration was 4.8 seconds. Consequently, it is apparent that the intensity of the sweetness of yogurt is intensified and the duration of maximum sweetness intensity can be increased by including an oxidized product of palm-based oil and fat containing carotene in the yogurt.

### Test Example 8

(Sensory Evaluation of Sweetness of Chocolate by the Time Intensity Method)

(Preparation and Evaluation of Chocolate)

Chocolate was prepared according to the blends shown in Table 11. Specifically, commercially available chocolate (Meiji Black Chocolate, manufactured by Meiji Co., Ltd.) was melted in a hot water bath, and the oxidized product (Example 27) prepared in Test Example 7 or rapeseed oil as a comparison was added so as to have a content of 0.2 mass %. The combination was placed in a mold and hardened in a refrigerator to prepare chocolate. The resulting chocolate was subjected to a sensory evaluation of chocolate sweetness using the Time Intensity method in the same manner as Test Example 7. In the present test example, chocolate was placed in the mouth five seconds after the start of measurement, and the chocolate was chewed at a pace of 2 times per second from the start of measurement to 15 seconds and then swallowed. The measurement was further continued until 60 seconds after the start of measurement, and the measurement was completed.

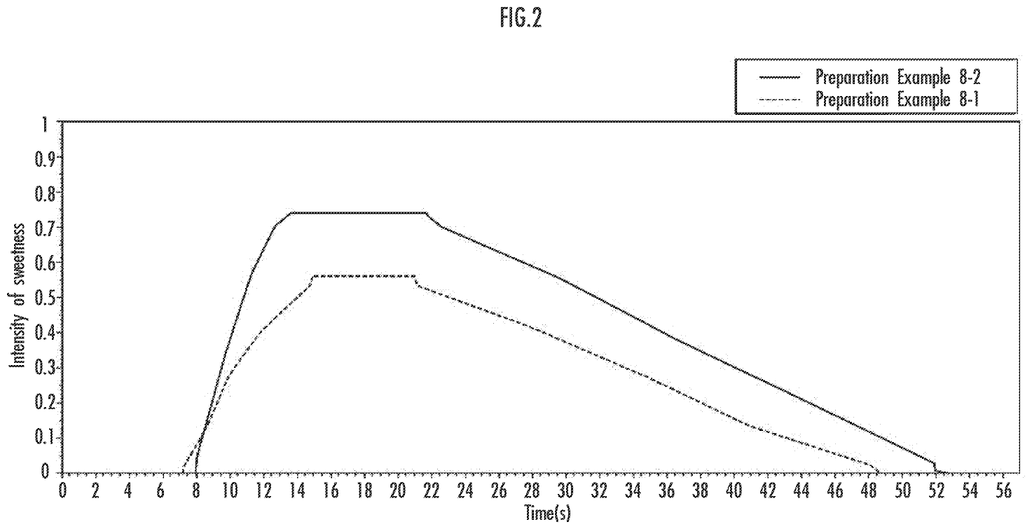

FIG. 2 shows the results of a sensory evaluation by the Time Intensity method.

TABLE 11

| | | Preparation | Preparation |
|---|---|---|---|
| | | Example 8-1 | Example 8-2 |
| Chocolate | | 49.9 | 49.9 |
| Rapeseed oil | | 0.1 | 0 |
| Oxidized product of Example 27 | | 0 | 0.1 |
| Total (parts by mass) | | 50 | 50 |
| Carotene content* (mass ppm) | | 0 | 7.46 × 10⁻¹ |
| Results | Max. | 0.57 | 0.75 |
| of sensory | sweetness | | |
| evaluation | intensity | | |
| by the Time | Duration | 6.1 | 8.1 |
| Intensity | (sec.) of max. | | |
| method | sweetness | | |
| | intensity | | |

*Carotene content in the chocolate: Amount converted to the total content of α-carotene and β-carotene prior to heating treatment

As a result, in Preparation Example 8-1 in which rapeseed oil was blended with chocolate, the maximum sweetness intensity was 0.57 and the duration was 6.1 seconds, whereas in Preparation Example 8-2 in which in the oxidized product of Example 27 had been blended, the maximum sweetness intensity was 0.75 and the duration was 8.1 seconds. Consequently, it is apparent that the intensity of the sweetness of chocolate is intensified and the duration of maximum sweetness intensity can be increased by including an oxidized product of palm-based oil and fat containing carotene in the chocolate.

### Test Example 9

(Evaluation of Yogurt Blended with Stevia as a Sweetener)

<Preparation and Evaluation of Yogurt)

Stevia (Stevia RA7J, manufactured by Ikeda Tohka Industries Co., Ltd.) as a sweetener was blended with yogurt using the blends shown in Table 12, the oxidized product (Example 27) prepared in Test Example 7 was then added to reach a content of 0.001 mass % or 0.01 mass % to prepare yogurt, and the resulting yogurt was subjected to a sensory evaluation. Specifically, the intensity of sweetness when yogurt is consumed (as first taste, middle taste, aftertaste) was evaluated by relative comparison with the case of adding the red palm oil (non-heat treatment) of Comparative Example 1 used for comparison in Test Example 1. The sensory evaluation was conducted by an expert panel of three people using an evaluation sheet in which the scores of −3, −2, −1, 0, 1, 2, and 3 indicating the following criteria were drawn on a 6 cm line segment at 0.1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 12

| | | Preparation | Preparation | Preparation |
|---|---|---|---|---|
| | | Example 9-1 | Example 9-2 | Example 9-3 |
| Yogurt | | 98.6 | 98.6 | 98.6 |
| Stevia | | 0.4 | 0.4 | 0.4 |
| Oil and | Rapeseed oil | 0.99 | 0.999 | 0.99 |
| fat | Non-oxidized product of | 0.01 | 0 | 0 |
| | comparative example 1 | | | |
| | Oxidized product of Example 27 | 0 | 0.001 | 0.01 |
| Total (parts by mass) | | 100 | 100 | 100 |
| Result of | Panel 1 | 0 | 1 | 1 |
| sensory | Panel 2 | 0 | 1.5 | 1 |
| evaluation | Panel 3 | 0 | 0.5 | 0.5 |
| (Sweetness of | | | | |
| first taste) | | | | |
| Average value (Sweetness of first taste) | | 0 | 1 | 0.83 |
| Result of | Panel 1 | 0 | 1 | 1.5 |
| sensory | Panel 2 | 0 | 2 | 2 |
| evaluation | Panel 3 | 0 | 1 | 1.5 |
| (Sweetness of | | | | |
| middle taste) | | | | |
| Average value (Sweetness of middle taste) | | 0 | 1.3 | 1.7 |
| Result of | Panel 1 | 0 | 1 | 2 |
| sensory | Panel 2 | 0 | 2 | 2 |
| evaluation | Panel 3 | 0 | 1 | 1.5 |
| (Sweetness of | | | | |
| aftertaste) | | | | |

| | | | |
|---|---|---|---|
| Average value (Sweetness of aftertaste) | 0 | 1.3 | 1.8 |

As a result, it is apparent that including an oxidized product of palm-based oil and fat containing carotene in the yogurt can enhance the sweetness thereof even when stevia, which is a sweetener with a high degree of sweetening, has been added to the yogurt.

### Test Example 10

(Evaluation with Donuts)

<Preparation of Oil and Fat for Heated Cooking>

The oxidized product of Example 27 was added to frying oil (J Fry-up 500, manufactured by J-Oil Mills Co., Ltd.) so as to have a mass of 10000 mass ppm to obtain oil and fat for heated cooking.

<Preparation and Evaluation of the Donuts>

The oil and fat for heated cooking prepared above was heated to 180° C., and the donut dough (donut mix, manufactured by Petit Pas) was fried for 50 seconds, turned over, and fried for another 80 seconds to obtain donuts 1. As a comparative control, donuts 2 were prepared by the same method except for the use of frying oil to which the oxidized product of Example 27 was not added. When the donuts were consumed and compared, the donuts 1 had more intense sweetness than the donuts 2.

From the foregoing, it is apparent that frying donuts in oil and fat for heated cooking in which an oxidized product of palm-based oil and fat containing carotene has been included makes it possible to enhance the sweetness of the donuts.

1. An oxidized product of a palm-based oil and fat, wherein the palm-based oil and fat has a total content of α-carotene and μ-carotene of 50 mass ppm or more and 2000 mass ppm or less, and a peroxide value of the oxidized product is 3 or more and 250 or less.

2. An oil and fat composition containing the oxidized product according to claim 1.

3. The oil and fat composition according to claim 2, which is for heated cooking.

4. A method for producing an oxidized product, comprising a step for oxidizing a palm-based oil and fat, which has a total content of α-carotene and β-carotene of 50 mass ppm or more and 2000 mass ppm or less, so that a peroxide value is 3 or more and 250 or less.

5. The production method according to claim 4, wherein the oxidizing step is carried out at a heating temperature of 50° C. or higher and 220° C. or lower, and a heating time of 0.1 hour or more and 240 hours or less.

6. The production method according to claim 4, wherein the oxidizing step is carried out by supplying oxygen to the palm-based oil and fat.

7. A method for enhancing food sweetness, wherein the oxidized product according to claim 1 is included in a food.

8. The method according to claim 7, wherein 1×10⁻⁸ mass % or more and 10 mass % or less of the oxidized product is included in the food.

9. A composition for enhancing food sweetness, comprising an oxidized product of a palm-based oil and fat.

10. The composition according to claim 9, comprising 1×10⁻⁸ mass % or more and 100 mass % or less of the oxidized product.

11. A food comprising the oxidized product according to claim 1.

12. A method for enhancing food sweetness, wherein the oil and fat composition according of claim 2 is included in a food.

13. The method according to claim 12, wherein 1×10⁻⁸ mass % or more and 10 mass % or less of the oxidized product is included in the food.
